(19) United States
(12) Patent Application Publication
(10) Pub. No.: US 2025/0193327 A1
(43) Pub. Date: Jun. 12, 2025

(54) READING DEVICE, IMAGE PROCESSING APPARATUS, READING METHOD, AND RECORDING MEDIUM

(71) Applicants: Yuichiro SHUKUYA, KANAGAWA (JP); Shogo NAKAMURA, KANAGAWA (JP)

(72) Inventors: Yuichiro SHUKUYA, KANAGAWA (JP); Shogo NAKAMURA, KANAGAWA (JP)

(21) Appl. No.: 18/969,277

(22) Filed: Dec. 5, 2024

(30) Foreign Application Priority Data
Dec. 12, 2023 (JP) 2023-209325

(51) Int. Cl. H04N 1/00

(52) U.S. Cl. CPC H04N 1/0071; H04N 1/00737; H04N 1/00782

(57) ABSTRACT

A reading device includes a light source, an imaging device, a first width detector, a second width detector, and circuitry. The light source irradiates a subject with light. The imaging device receives the light reflected off the subject and generates an image. The first width detector detects a width of the subject. The second width detector detects the width of the subject using a different method from the first width detector. The circuitry determines a size of the subject. When the first width detector has detected the width of the subject normally, the circuitry determines the width of the subject based on a detection result of the first width detector. When the first width detector has not detected the width of the subject normally, the circuitry determines the width of the subject based on a detection result of the second width detector.

### CROSS-REFERENCE TO RELATED APPLICATIONS

This patent application is based on and claims priority pursuant to 35 U.S.C. § 119 (a) to Japanese Patent Application No. 2023-209325, filed on Dec. 12, 2023, in the Japan Patent Office, the entire disclosure of which is hereby incorporated by reference herein.

### BACKGROUND

### Technical Field

Embodiments of the present disclosure relate to a reading device, an image processing apparatus, a reading method, and a recording medium.

### Related Art

The background reading device automatically detects the size of a read subject (e.g., a document) through image processing and crops an image according to the detected size.

When the background reading device has failed to automatically detect the document size of a document through image processing (edge detection), the reading device uses the width of side fences to determine the image size.

### SUMMARY

According to an embodiment of the present disclosure, a reading device includes a light source, an imaging device, a first width detector, a second width detector, and circuitry. The light source irradiates a subject with light. The imaging device receives the light reflected off the subject and generates an image. The first width detector detects a width of the subject. The second width detector detects the width of the subject using a different method from the first width detector. The circuitry determines a size of the subject. When the first width detector has detected the width of the subject normally, the circuitry determines the width of the subject based on a detection result of the first width detector. When the first width detector has not detected the width of the subject normally, the circuitry determines the width of the subject based on a detection result of the second width detector.

According to an embodiment of the present disclosure, an image processing apparatus includes the above-described reading device and an image forming device to form an image of a document that is the subject.

According to an embodiment of the present disclosure, a reading method for reading a subject is performed by a reading device including a first width detector and a second width detector. The reading method includes determining whether the first width detector has detected a width of the subject normally, when the determining determines that the first width detector has detected the width of the subject normally, determining the width of the subject based on a detection result of the first width detector, and when the determining determines that the first width detector has not detected the width of the subject normally, determining the width of the subject based on a detection result of the second width detector that detects the width of the subject using a different method from the first width detector.

According to an embodiment of the present disclosure, a non-transitory recording medium storing a plurality of instructions which, when executed by one or more processors, causes the one or more processors to perform the above-described reading method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an image forming apparatus according to a first embodiment of the present disclosure;

FIG. 2 is a diagram illustrating an example hardware configuration of an image reading device;

FIG. 3 is a diagram illustrating an example arrangement of a document width sensor;

FIG. 4 is a diagram illustrating an example configuration of a reading device;

FIG. 5 is a block diagram illustrating an electrical connection of components included in the image reading device;

FIG. 6 is a block diagram illustrating a functional configuration of an image processor;

FIG. 7 is a graph illustrating the difference in spectral reflectance characteristics that vary depending on the type of medium;

FIGS. 8A and 8B are views illustrating the difference between visible images and invisible images as an example;

FIGS. 9A and 9B are diagrams illustrating an example of the edge detection of a subject;

FIGS. 10A to 10C are diagrams illustrating an example of correcting the tilt and position of a document;

FIG. 11 is a diagram illustrating information obtained from edges of the subject;

FIGS. 12A and 12B are diagrams illustrating an example edge detection method;

FIGS. 13A and 13B are diagrams illustrating an example feature value using edges;

FIG. 14 is a diagram illustrating the selection of a linear expression in an expression for a regression line;

FIG. 15 is a flowchart illustrating a flow of image cropping processing;

FIG. 16 is a diagram illustrating another example arrangement of the document width sensor;

FIG. 17 is a diagram illustrating a still another example arrangement of the document width sensor;

FIG. 18 is a top view of an exposure glass;

FIG. 19 is a diagram illustrating example image data levels;

FIG. 20 is a diagram illustrating processing that is performed for determining the document size using the document width sensor according to a second embodiment of the present disclosure;

FIG. 21 is a diagram illustrating another example of processing performed when the document size is determined using the document width sensor;

FIG. 22 is a diagram illustrating a still another example of the processing performed when the document size is determined using the document width sensor;

FIG. 23 is a block diagram illustrating an electrical connection of components included in the image reading device according to a third embodiment of the present disclosure;

FIG. 24 is a block diagram illustrating a functional configuration of the image processor;

FIG. 25 is a view illustrating an example display on an operation device when the document is read by an automatic document feeder (ADF);

FIG. 26 is a view illustrating an example display on the operation device in the case of flatbed reading;

FIGS. 27A to 27C are views illustrating a modification of a reading device;

FIG. 28 is a diagram illustrating another modification of the reading device; and

FIG. 29 is a diagram illustrating an example arrangement of the document width sensor.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A reading device, an image processing apparatus, a reading method, and a recording medium according to embodiments of the present disclosure are described in detail below with reference to the attached drawings.

### First Embodiment

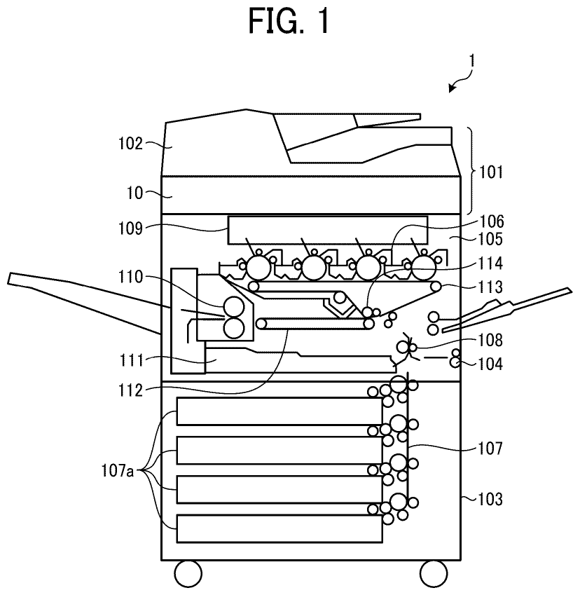

FIG. 1 is a diagram illustrating an example configuration of an image forming apparatus 1 according to a first embodiment of the present disclosure. In FIG. 1, the image forming apparatus 1, which is an example of an image processing apparatus, is a multifunction peripheral having at least two functions among a copy function, a printer function, a scanner function, and a facsimile function.

The image forming apparatus 1 includes an image reading device 101, which is an example of a reading device, and an image forming device 103, which is disposed under the image reading device 101. In order to describe an internal configuration of the image forming device 103, the image forming device 103 is illustrated in FIG. 1 with an external cover of the image forming device 103 removed.

The image reading device 101 includes an automatic document feeder (ADF) 102, which is mounted on the top of a body 10 of the image reading device 101. The body 10 of the image reading device 101 includes a reading device of the image reading device 101, which will be described below. The ADF 102 is a document supporter that positions, at a reading position, a document from which an image is read. The ADF 102 automatically conveys the document placed on a placement table to the reading position. The image reading device 101 reads the document conveyed by the ADF 102 at the predetermined reading position. The image reading device 101 also includes an exposure glass 11 on an upper face of the image reading device 101. The exposure glass 11 is a document supporter on which the document is placed. The image reading device 101 reads the document on the exposure glass 11 at the reading position. Specifically, the image reading device 101 is a scanner including a light source, an optical system, and a solid-state image sensor such as a complementary metal-oxide-semiconductor (CMOS) image sensor. In the image reading device 101, the light source illuminates the document and the solid-state image sensor reads the light reflected off the document via the optical system.

The image forming device 103 includes a manual feeding roller pair 104, through which a recording sheet is manually inserted, and a recording sheet supplier 107, which supplies a recording sheet. The recording sheet supplier 107 has a mechanism that sends out a recording sheet from any of vertically-stacked recording sheet cassettes 107a. The supplied recording sheet is conveyed to a secondary transfer belt 112 via a resist roller pair 108.

The recording sheet conveyed on the secondary transfer belt 112 is conveyed to a transfer device 114 where a toner image on an intermediate transfer belt 113 is transferred onto the recording sheet.

The image forming device 103 also includes an optical writing device 109, tandem image forming units 105 for colors of yellow (Y), magenta (M), cyan (C), and black (K), the intermediate transfer belt 113, and the secondary transfer belt 112. Each of the Y, M, C, and K image forming units 105 of the image forming device 103 performs an image forming process to form an image written by the optical writing device 109 on the intermediate transfer belt 113 as a toner image.

Specifically, the image forming units 105 of the Y, M, C, and K colors include four rotatable photoconductor drums of the Y, M, C, and K colors, respectively. Each of the four photoconductor drums is surrounded by image forming components 106 including a charging roller, a developing device, a primary transfer roller, a cleaner, and a neutralizer. The image forming components 106 around the respective four photoconductor drums function such that the primary transfer rollers transfer images from the respective photoconductor drums onto the intermediate transfer belt 113.

The intermediate transfer belt 113 is entrained around a drive roller and a driven roller in a nip between the four photoconductor drums and the respective primary transfer rollers. As the intermediate transfer belt 113 rotates, a composite toner image including the toner images primarily transferred onto the intermediate transfer belt 113 is conveyed to a secondary transfer device where the composite toner image is secondarily transferred onto the recording sheet on the secondary transfer belt 112. As the secondary transfer belt 112 rotates, the recording sheet is conveyed to a fixing device 110. The fixing device 110 then fixes the composite toner image as a color image onto the recording sheet. Subsequently, the recording sheet is ejected onto an ejection tray disposed outside the image forming apparatus 1. In the case of duplex printing, a reverse mechanism 111 reverses the front and back faces of the recording sheets and sends out the reversed recording sheet onto the secondary transfer belt 112.

The image forming device 103 is not limited to an electrophotographic image forming device that forms an image by an electrophotographic system as described above. The image forming device 103 may be an inkjet image forming device that forms an image by an inkjet system.

Next, the image reading device 101 is described below.

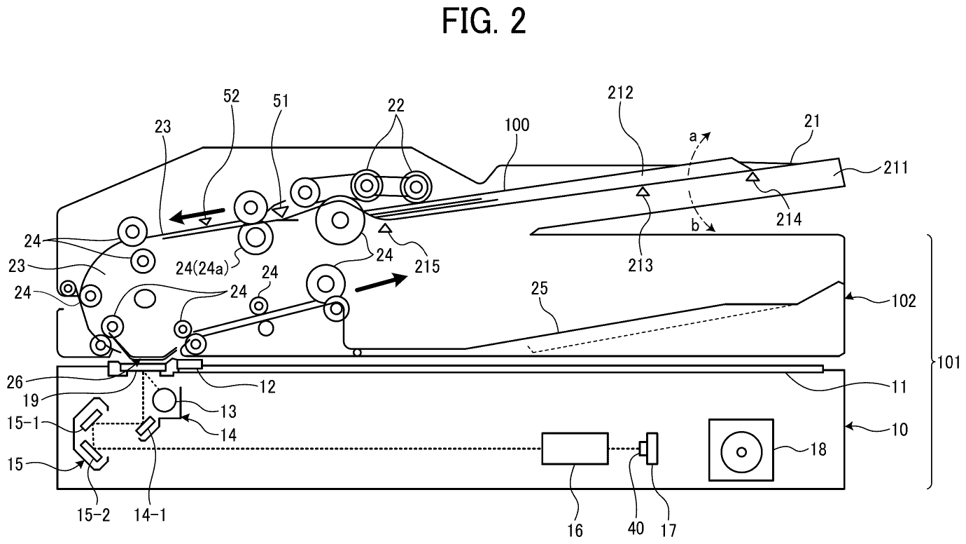

FIG. 2 is a diagram illustrating an example hardware configuration of the image reading device 101. The body 10 of the image reading device 101 includes the exposure glass 11 on the upper face of the body 10. The image reading device 101 includes a light source 13, a first carriage 14, a second carriage 15, a lens unit 16, and a sensor board 17 in the body 10. In FIG. 2, the first carriage 14 includes the light source 13 and a reflective mirror 14-1, and the second carriage 15 includes reflective mirrors 15-1 and 15-2.

The light from the light source 13 is emitted to a reading target and the light reflected off the reading target is reflected off the reflective mirror 14-1 of the first carriage 14 and the reflective mirrors 15-1 and 15-2 of the second carriage 15 and enters the lens unit 16. Accordingly, an image of the reading target is formed on a light-receiving face of the sensor board 17 via the lens unit 16. The sensor board 17 includes an imaging device 40, which is a line sensor such as a charge-coupled device (CCD) or a CMOS. The imaging device 40 of the sensor board 17 sequentially converts the image of the reading target formed on the light-receiving face into an electrical signal. The image reading device 101 includes a reference white plate 12, which serves as a density reference for white color that is read to correct, for example, a change in the light intensity of the light source 13 and variations in the pixels (pixel circuits) of the imaging device 40.

The body 10 of the image reading device 101 includes a control board. The control board controls various components included in the body 10 and the ADF 102 to read a reading target using a predetermined reading system. The reading target is, for example, a recording medium on which, for example, at least one of a character and a picture is formed. Hereinafter, such a recording medium is referred to as a “document.” The “document” corresponds to a “subject.” Although the “document” is described herein as a sheet of paper or a transparent sheet such as an overhead projector (OHP) sheet as an example, the document is not limited thereto.

The image reading device 101 reads a document 100 using the ADF 102 by a sheet-through system. The ADF 102 is an example of a “conveyor.” In the configuration illustrated in FIG. 2, a pickup roller 22 of the image reading device 101 separates documents 100 one by one from a bundle of documents 100 placed on a tray 21 of the ADF 102. Then, the separated document 100 is conveyed to a conveyance path 23 and then reaches a reading position of the reading device where a face of the document 100 as the reading target is read. After that, the document 100 is ejected onto an ejection tray 25. The document 100 is conveyed as various conveyance roller pairs 24 rotate.

The various conveyance roller pairs 24 include a pull-out roller pair 24a, which is a pair of rollers that primarily abuts against and aligns the fed document 100 (corrects the skew of the document 100) and pulls out and conveys the aligned document 100. The pull-out roller pair 24a is adjacent to a contact sensor 51.

The tray 21 includes a movable document table 211 and a pair of side guide plates 212. The movable document table 211 turns in directions indicated by arrows “a” and “b” of FIG. 2 with its proximal end serving as a fulcrum. The pair of side guide plates 212 determines the left and right positions of the document 100 in a document feeding direction. Turning of the movable document table 211 aligns a front end of the document 100 in the document feeding direction to an appropriate height.

The tray 21 is provided with document length detection sensors 213 and 214. The document length detection sensors 213 and 214 are disposed at a distance in the document feeding direction and detect whether the document 100 is oriented vertically or horizontally. The document length detection sensors 213 and 214 may be reflective sensors that detect the orientation of the document 100 by optical means without contact. The document length detection sensors 213 and 214 may be contact-type actuator sensors.

The pair of side guide plates 212 is slidable in a lateral direction relative to the document feeding direction to allow documents 100 of different sizes to be placed. The pair of side guide plates 212 includes a document set sensor 215 to detect the placement of the document 100 on the tray 21.

The conveyance path 23 downstream of the pull-out roller pair 24a in the document conveyance direction includes a document width sensor 52, which is an example of a second width detector.

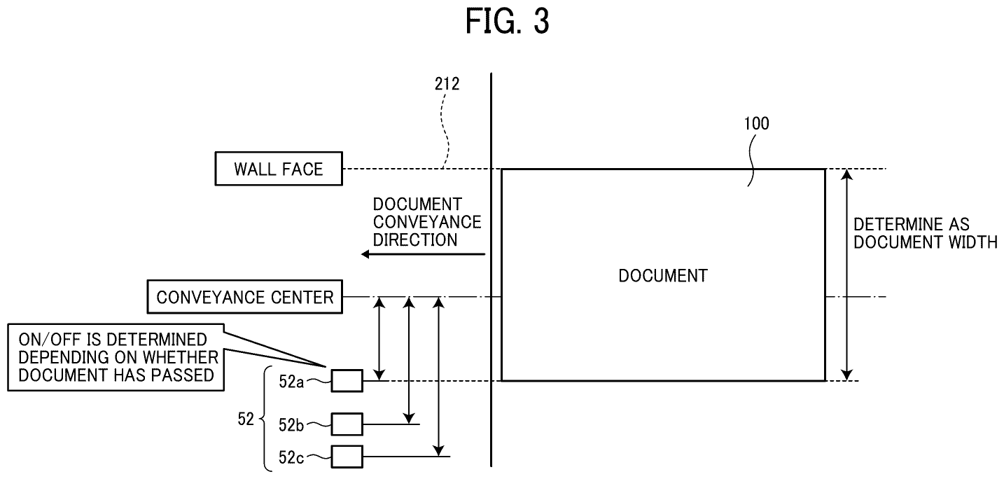

FIG. 3 is a diagram illustrating an example arrangement of the document width sensor 52. As illustrated in FIG. 3, as an example, the document width sensor 52 includes light-receiving devices 52a, 52b, and 52c, which are sensors. The light-receiving devices 52a, 52b, and 52c are arranged in a lateral direction of documents 100 so as to correspond to the standard document sizes of the documents 100 placed along one of the side guide plates 212 serving as a document placement reference. The light-receiving devices 52a, 52b, and 52c are located opposite of a location where the side guide plates 212 are located, with respect to the conveyance direction that is represented by a line passing the center of the conveyance path 23 in the width direction (that is, the center of the maximum-possible width through which the document 100 can be conveyed). The document width sensor 52 detects the document width of each document 100 (for each subject) based on the result of receiving light from a light source disposed at an opposite side across the conveyance path 23. The length of each document 100 in the document conveyance direction is detected from the motor pulse generated when the contact sensor 51, which is disposed in the vicinity of the pull-out roller pair 24a, reads a front end and a rear end of the document 100.

For example, the image reading device 101 causes the first carriage 14 and the second carriage 15 to move to a predetermined home position and then causes the document 100 to pass between a reading window 19 and a background member 26 with the first carriage 14 and the second carriage 15 fixed at the predetermined home position. The reading window 19 is a slit-shaped reading window disposed on part of the exposure glass 11. The background member 26 is positioned opposite the reading window 19. In the reading device, while the document 100 is passing the reading window 19, the light source 13 irradiates a first face (a front face or a back face) of the document 100 facing the reading window 19 with light, and then the imaging device 40 on the sensor board 17 receives the reflected light to read an image. The background member 26 may be of any size as long as the background member 26 fits within an imaging range of the imaging device 40. The background member 26 is, for example, a sheet metal or a roller.

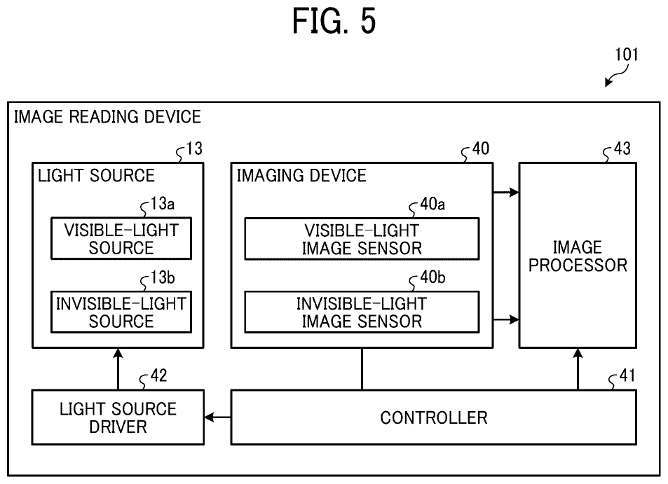

In the present embodiment, the reading device includes, for example, the light source 13, the background member 26, the optical system, and the imaging device 40. The optical system includes, for example, the mirror 14-1, the mirrors 15-1 and 15-2, and the lens unit 16 and guides the light reflected off the document 100 to the imaging device 40 on the sensor board 17. A configuration of the reading device is described with reference to FIG. 5.

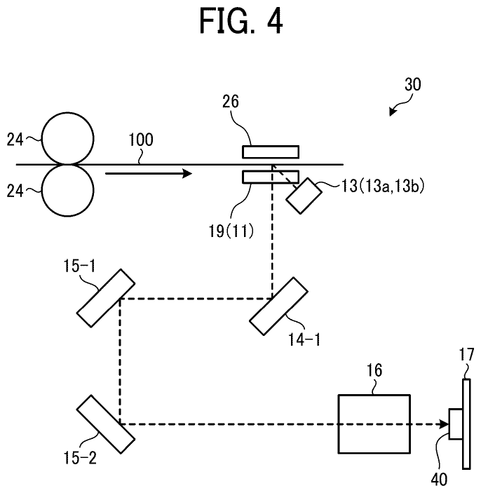

In the case of performing double-sided reading of the document 100, for example, a reverse mechanism may be disposed to reverse first and second faces of the document 100. In this case, the reverse mechanism disposed in the image reading device 101 reverses the document 100 so that the second face of the document 100 is read at the reading position (reading window 19) of the reading device. Alternatively, for example, a second reading device may be disposed to read the second face of the document 100, in addition to the above-described reading device that may be referred to as the first reading device. In this case, after the document 100 has passed the reading window 19, the reading device (second reading device) including a reading sensor disposed at a position facing the second face of the document 100 reads the second face of the document 100. In this case, a component disposed at a position opposite the reading sensor serves as the background member 26 (see FIG. 4).

The image reading device 101 according to the present embodiment also has a configuration to perform flatbed reading. Specifically, the ADF 102 is lifted to expose the exposure glass 11, and the document 100 is directly placed on the exposure glass 11. Then, the ADF 102 is lowered to the original position so that the back face of the document 100 is pressed and held by a lower portion of the ADF 102. In the flatbed reading, since the document 100 is fixed, the first carriage 14 and the second carriage 15 move relative to the document 100 to scan the document 100. The first carriage 14 and the second carriage 15 are driven by a scanner motor 18 to scan the document 100 in a sub-scanning direction. For example, the first carriage 14 moves at a speed of V and, at the same time, the second carriage 15 moves at a speed of ½ V, which is half the speed of the first carriage 14, in conjunction with the movement of the first carriage 14 to read the first face of the document 100 facing the exposure glass 11. In this example, the lower portion of the ADF 102 that presses and holds the document 100 from the back face serves as the background member 26 (see FIG. 4).

In the present embodiment, the first carriage 14, the second carriage 15, the lens unit 16, and the sensor board 17 are separate components. These components may be disposed individually or provided as an integrated sensor module integrally including these components.

FIG. 4 is a diagram illustrating an example configuration of a reading device 30, as an example of the reading device of the image reading device 101. As an example, FIG. 4 illustrates the configuration of the reading device 30 (first reading device), which reads the first face of the document 100, and a conveyance mechanism. As illustrated in FIG. 4, the document 100 is fed by the various conveyance roller pairs 24 and passes between the reading position (reading window 19) of the exposure glass 11 and the background member 26.

The reading device 30 also includes the background member 26. While the document 100 is passing the reading window 19, the light source 13 irradiates the first face of the document 100 facing the reading window 19 with light, and then the imaging device 40 on the sensor board 17 receives the reflected light via a path indicated by a dotted line of FIG. 4 to read an image.

The configuration of the reading device is not limited to the configuration of the first reading device. For example, the reading device may use a contact image sensor to read the document 100 as with the second reading device or may be modified as appropriate according to the configuration of the image reading device 101.

As illustrated in FIG. 4, the light source 13 according to the present embodiment includes a visible-light source 13a and an invisible-light source 13b to serve as an illumination device that irradiates the subject with visible light and invisible light. The visible-light source 13a irradiates the subject and the background member 26 with visible light. The invisible-light source 13b irradiates the subject and the background member 26 with invisible light. It is effective that the invisible-light source 13b emits infrared light as invisible light. Generally, a visible light wavelength range is 380 nm to 750 nm, and an infrared wavelength range is 750 nm or more, which is the invisible light wavelength range.

In the present embodiment, the invisible-light source 13b emits invisible light in the infrared wavelength range of 750 nm or more. However, the present disclosure is not limited thereto and the invisible-light source 13b may emit invisible light in an ultraviolet wavelength range of 380 nm or less.

FIG. 5 is a block diagram illustrating an electrical connection of components included in the image reading device 101. As illustrated in FIG. 5, the image reading device 101 includes the imaging device 40, the light source 13, a controller 41, a light source driver 42, and an image processor 43. The controller 41 controls the imaging device 40, the light source driver 42, and the image processor 43. The light source driver 42 drives the light source 13 under the control of the controller 41. The imaging device 40 transfers signals to the image processor 43 at a subsequent stage.

The imaging device 40 includes a visible-light image sensor 40a and an invisible-light image sensor 40b. The visible-light image sensor 40a functions as a visible image reading device. The invisible-light image sensor 40b functions as an invisible image reading device. The imaging device 40 receives visible light and invisible light reflected off the subject and captures a visible image and an invisible image. Specifically, the visible-light image sensor 40a reads visible reflection light reflected off the subject to obtain a visible image (an image in a visible light wavelength region). The visible reflection light is part of the visible light emitted from the visible-light source 13a. The invisible-light image sensor 40b reads invisible reflection light reflected off the subject to obtain an invisible image (an image in an invisible light wavelength region). The invisible reflection light is part of the invisible light emitted from the invisible-light source 13b. The visible-light image sensor 40a and the invisible-light image sensor 40b are sensors for a reduced optical system. For example, the visible-light image sensor 40a and the invisible-light image sensor 40b may be CMOS image sensors.

The visible-light image sensor 40a and the invisible-light image sensor 40b may be an integrated image sensor. The integrated image sensor has a reduced size, thereby reducing the distance between the position where visible light is read and the position where infrared light is read. This configuration allows the integrated image sensor to extract and restore lost information with high precision. In other words, this configuration eliminates deviation of an image that would otherwise be caused by multiple readings and ensures that correction is performed with high position accuracy.

The image processor 43 performs various image processing according to the purpose of use of image data. The image processor 43 may be implemented by hardware circuitry or a central processing unit (CPU) executing a program.

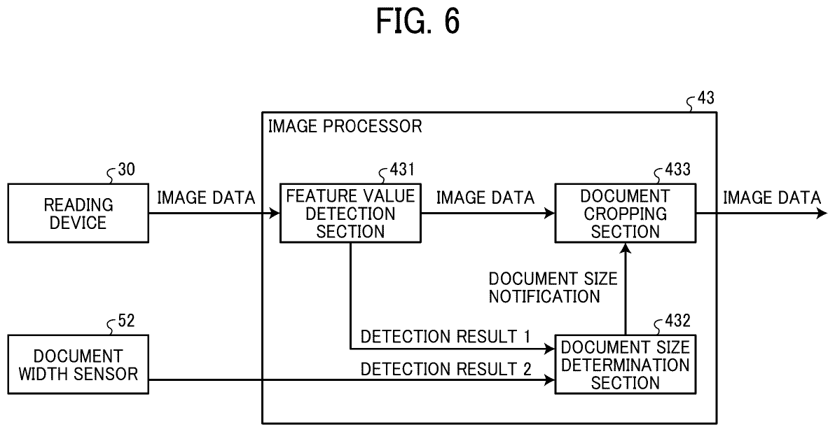

FIG. 6 is a block diagram illustrating a functional configuration of the image processor 43. As illustrated in FIG. 6, the image processor 43 includes a feature value detection section 431, which is a first width detector, a document size determination section 432, which is a width determination section, and a document cropping section 433.

The feature value detection section 431 of the image processor 43 detects the feature value of the subject or the background member 26 from at least one of the visible image and the invisible image obtained by the image reading device 101. Examples of the feature value include an edge between the background member 26 and the document 100. As described in detail later, the image processor 43 uses the detected feature value to correct an image itself.

The feature value detection section 431 functions as an edge detector that detects an edge of the subject in a main scanning direction. Specifically, the feature value detection section 431 detects an edge by a method such as a method of detecting an edge from the density difference between the read document 100 and the background member 26, or a method of detecting a shadow between the read document 100 and the background member 26. The feature value detection section 431 regards, as an edge of the document 100, a portion where the amount of change in the image density exceeds a predetermined value. In the present embodiment, edge detection refers to detecting edges of right and left ends of the document 100 or detecting an edge of the document 100 in a detectable range in a main scanning area at an upper end of the document 100.

The document size determination section 432 receives a result of edge detection from the feature value detection section 431 or a result of detection from the document width sensor 52 and determines the size of the document 100. Specifically, when the feature value detection section 431 detects the edges of the opposite ends of the document 100 in the main scanning direction (when the edges are not outside the detectable range), the document size determination section 432 determines the width of the document 100 in the main scanning direction.

The document cropping section 433 crops an image of the document 100 according to the size of the document 100 determined by the document size determination section 432 or according to the size of the document 100 detected by the document width sensor 52. When the document size determination section 432 determines the size of the document 100 based on the result of the edge detection performed by the feature value detection section 431, the document cropping section 433 crops the image into the size that matches the size of the document 100.

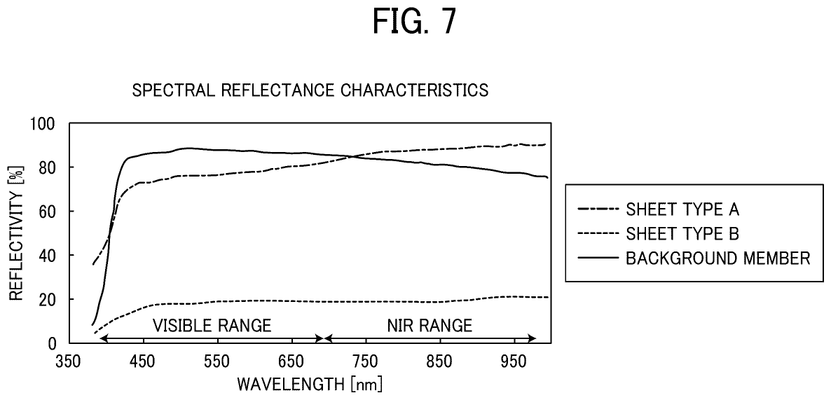

The spectral reflectance characteristics vary depending on the type of medium in the imaging device 40. Such differences are described below with reference to FIG. 7.

FIG. 7 is a graph illustrating the difference in spectral reflectance characteristics that vary depending on the type of medium. Specifically, FIG. 7 illustrates the spectral reflectance characteristics of a sheet type A, a sheet type B, and the background member 26. The sheet type A and the sheet type B are plain sheets that are used as documents and to be read by the image reading device 101. In FIG. 7, a dashed-dotted line graph represents the spectral reflectance characteristic of the plain sheet (sheet type A), a dotted-line graph represents the spectral reflectance characteristic of the plain sheet (sheet type B), and a solid-line graph represents the spectral reflectance characteristic of the background member 26.

As illustrated in FIG. 7, in the visible wavelength range, the reflectivity of the background member 26, which is a white background, is higher than the reflectivity of the plain sheet (sheet type A). However, in the near-infrared (NIR) wavelength range, the reflectivity of the background member 26 is lower than the reflectivity of the plain sheet (sheet type A).

As illustrated in FIG. 7, the reflectivity of the background member 26 is higher than the reflectivity of the plain sheet (sheet type B) in both the visible wavelength range and the NIR wavelength range.

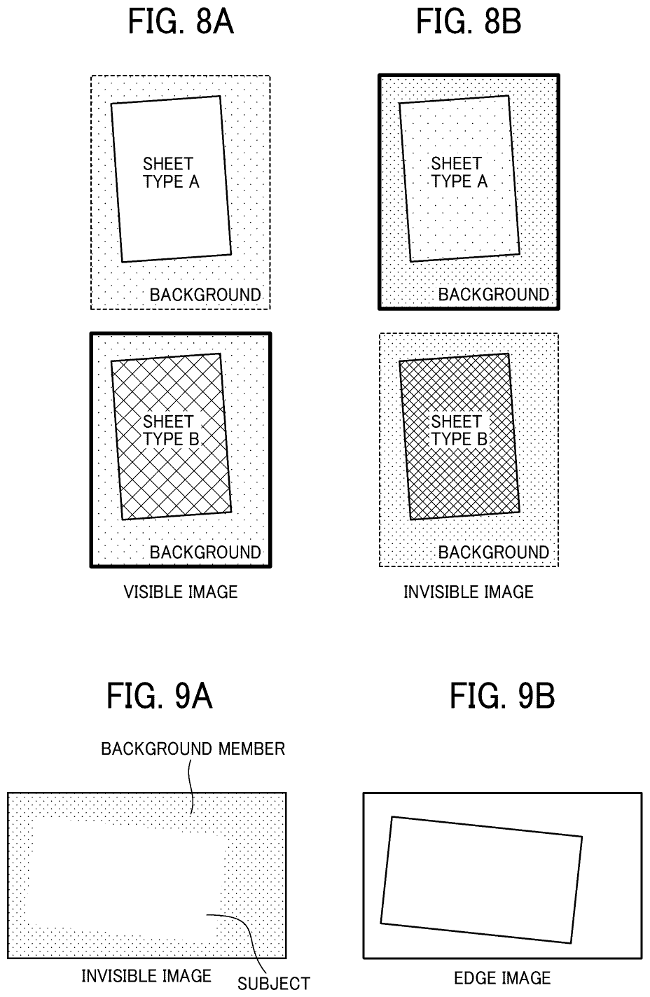

FIGS. 8A and 8B are views illustrating the difference between visible images and invisible images as an example. As illustrated in FIGS. 8A and 8B, when the imaging device 40 reads reflected light, the spectral reflectance characteristics are different between the background member 26 and the document, and visible light and invisible light generate images with different feature values. Therefore, in order to obtain a desired feature value more easily, a visible image or an invisible image may be selected in advance for an image to be detected, according to the type of subject or the type of background member 26.

For example, in the case of the sheet type A illustrated in FIGS. 8A and 8B, the difference in spectral reflectance characteristics between the background member 26 and the document is greater in the invisible image than in the visible image. For the sheet type A, therefore, the invisible image is set as an image from which the feature value is detected. For the sheet type B, the visible image is set as an image from which the feature value is detected.

Alternatively, the feature value may be extracted from each of the visible image and the invisible image. In this case, a feature value may be selected from the extracted feature values or the extracted feature values may be combined.

The following describes an example of how the feature value detection section 431 detects the edges of the document 100, which is the subject, and corrects the tilt and position of the document 100.

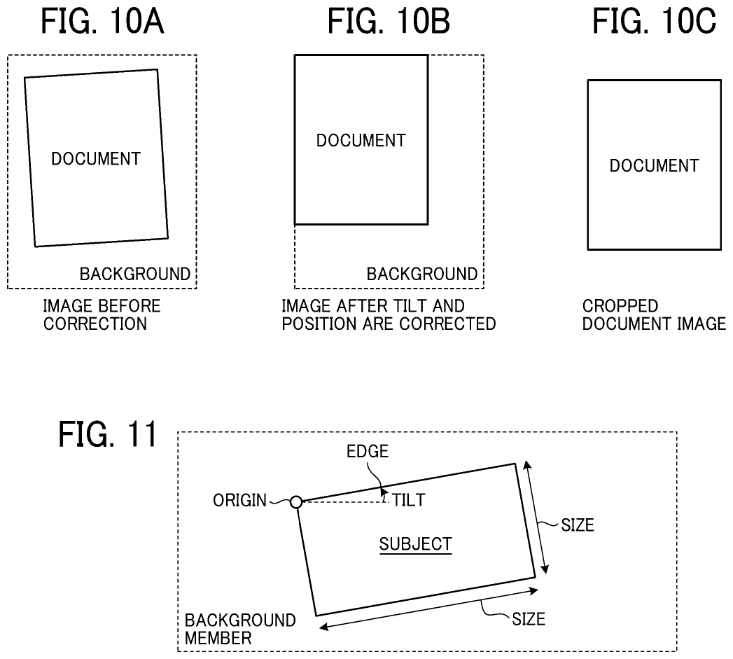

FIGS. 9A and 9B are diagrams illustrating an example of the edge detection of the subject. FIGS. 10A to 10C are diagrams illustrating an example of correcting the tilt and position of the document 100. FIG. 11 is a diagram illustrating information obtained from edges of the subject. For example, as illustrated in FIGS. 9A and 9B, it is desirable to reduce the reflectivity of the background member 26 and use an invisible image to extract edges between the background member 26 and the document 100 from the image. Further, as illustrated in FIGS. 10A to 10C, it is desirable to reduce the reflectivity of the background member 26 and use an invisible image to correct the tilt and position of the document 100 and crop the document image. Reading with invisible light in this way obtains an image in which the document 100 is bright and the background member 26 is dark since the reflectivity of the background member 26 is low with invisible light. This makes the difference between the document 100 and the background member 26 clearer, making it easier to detect the edges. In other words, an increase in density difference between the document 100 and the background member 26 increases the precision of the edge detection.

As illustrated in FIG. 11, an edge refers to the boundary between the document 100, which is the subject, and the background member 26. Based on the detected edge, as illustrated in FIG. 11, the position, tilt, and size of the document 100, which is the subject, are recognized. Based on the position, tilt, and size of the document 100, which is the subject, image correction may be performed in later processing according to the position, tilt, and size of the document 100, which is the subject.

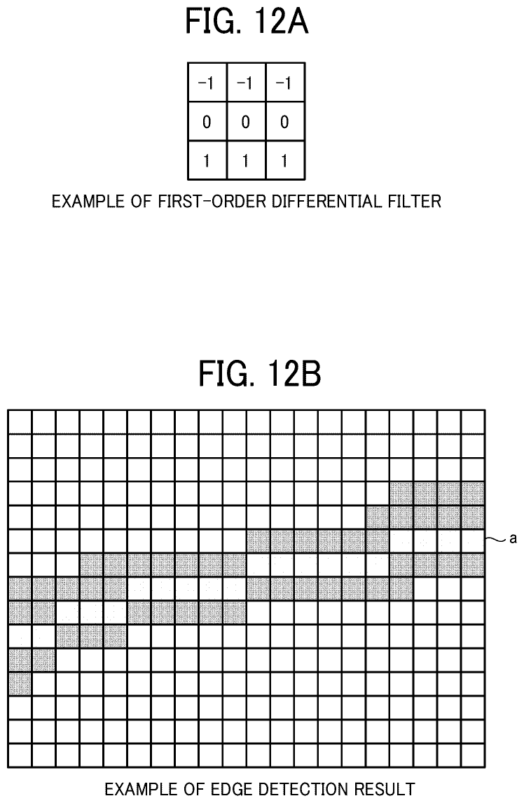

FIGS. 12A and 12B are diagrams illustrating an example edge detection method. In order to detect an edge, for example, as illustrated in FIG. 12A, a first-order differential filter may be applied to the entire image, and each pixel may be binarized depending on whether the pixel has a value exceeding a predetermined threshold value. In such a method, an edge in a horizontal direction appears in several continuous pixels in a vertical direction depending on the threshold value, and vice versa. This is mainly because an edge is blurred due to the modulation transfer function (MTF) characteristics of the optical system. In order to deal with such a situation, as illustrated in FIG. 12B, for example, the center of the continuous pixels may be selected as indicated by “a” of FIG. 12B to obtain a representative edge pixel for, for example, the calculation of an expression for a regression line and the detection of the size to be described later.

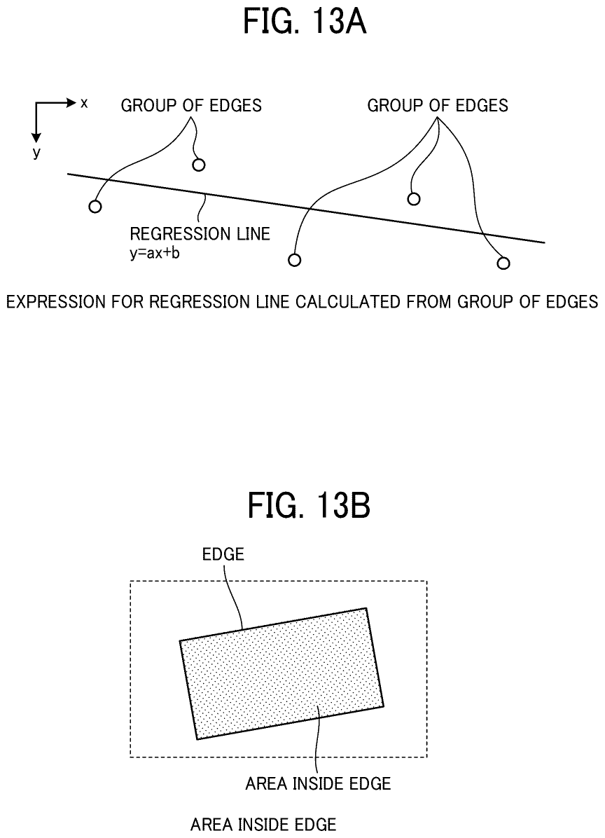

FIGS. 13A and 13B are diagrams illustrating an example feature value using edges. Alternatively, the feature value may be obtained using edges, instead of an edge itself extracted from an image. One example is, as illustrated in FIGS. 13A and 13B, to use an expression for the regression line calculated from an extracted group of edges using, for example, a method of least squares or an area inside the edge (aggregate of points). As for the expression for the regression line, a method may be employed in which one linear expression is obtained from the edge of each side. Alternatively, a method may be employed in which a plurality of linear expressions is separately calculated and obtained from a plurality of divided areas and a representative one of the plurality of linear expressions is selected or representative ones of the plurality of linear expressions are integrated. In this case, when a final linear expression is obtained, a linear expression having a median angle of tilt may be obtained, or an average value of a plurality of linear expressions may be obtained.

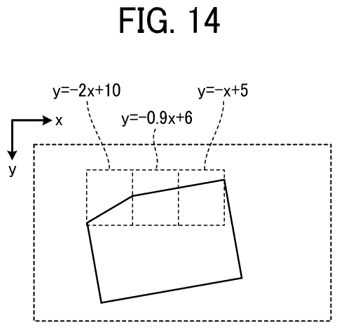

FIG. 14 is a diagram illustrating the selection of a linear expression in an expression for a regression line. As illustrated in FIG. 14, a plurality of linear expressions is separately calculated and obtained from a plurality of divided areas, and a representative one of the plurality of linear expressions is selected or representative ones of the plurality of linear expressions are integrated. Through this processing, as illustrated in FIG. 14, even when, for example, an end of the document 100, which is the subject, is damaged or lost, the angle of tilt of the document 100, which is the subject, is recognized correctly.

Through the processing described above, the feature value detection section 431 extracts the edges of the document 100, which is the subject, as the feature values to detect the area of the document 100.

As described above, the image reading device 101 according to the present embodiment may use the document width sensor 52 to detect the width of the document 100.

As illustrated in FIG. 3, as an example, the document width sensor 52 includes the light-receiving devices 52a, 52b, and 52c, which are arranged in the lateral direction of the document 100. The light-receiving devices 52a, 52b, and 52c of the document width sensor 52 are positioned so as to determine which standard size the document 100 is in. Therefore, when the document 100 having a standard size passes, the document size of the document 100 is determined based on the position information of a reacting light-receiving device among the light-receiving devices 52a, 52b, and 52c of the document width sensor 52.

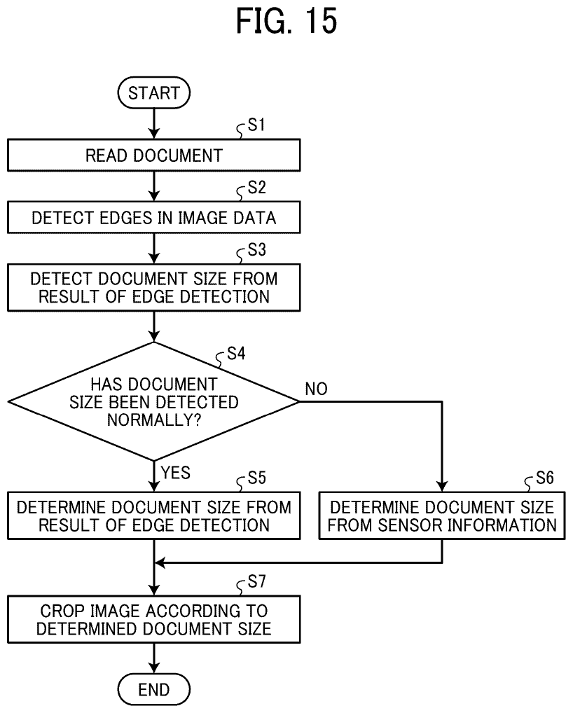

Next, a flow of image cropping processing performed by the image reading device 101 is described with reference to FIG. 15.

As described above, the image reading device 101 according to the present embodiment includes two different width detectors to detect the width of the document 100. The first width detector extracts the edges of the document 100 from image data through image processing to detect the document size. The second width detector detects the document size of the document 100 from the result of the document detection performed by the document width sensor 52.

FIG. 15 is a flowchart illustrating a flow of the image cropping processing. As illustrated in FIG. 15, in step S1, the image reading device 101 controls the reading device 30 to read the document 100.

In step S2, the feature value detection section 431 detects edges of the document 100 in an image of the read document 100. In step S3, the document size determination section 432 detects the document size from the result of the edge detection.

When the document size determination section 432 determines that the document size of the document 100 has been detected normally (Yes in step S4), the document size determination section 432 determines the document size of the document 100 from the result of the edge detection in step S5. For example, when the document size within a predetermined size range has been detected (e.g., the document size between the minimum sheet size and the maximum sheet size guaranteed by the product has been detected), the document size determination section 432 determines that the document size of the document 100 has been detected normally.

When the document size determination section 432 determines that the document size of the document 100 has not been detected normally (No in step S4), the document size determination section 432 determines the document size of the document 100, whose image has been read, from the detection result (sensor information) of the document 100 obtained from the document width sensor 52 in step S6. When the document size determination section 432 determines that the document size of the document 100 has not been detected normally, it is indicated that the detection of the document size of the document 100 has resulted in “abnormal.” For example, when the edge detection has failed or when the edge detection has been successful but the image size has been detected as being smaller than a predetermined size (e.g., the document size has been determined to be less than the minimum sheet size guaranteed by the product), the document size determination section 432 determines that the document size of the document 100 has not been detected normally.

In the present embodiment, when the document size determination section 432 has not detected the document size of the document 100 normally, the document size determination section 432 determines the document size of the document 100 using the detection result (sensor information) of the document width sensor 52. The document size determination section 432 determines the document size of the document 100, for example, the location information of the sensor that is placed at one or two positions away from the location where the sensor detecting the presence of the document, in an outward direction with respect to the document placement reference.

When a bundle of mixed documents 100 with different sizes is placed on the tray 21, the side guide plates 212 of the tray 21 are adjusted so as to match the size of a document 100 having the largest size among the bundle of mixed documents 100. Therefore, in a case where the position information detected by the document length detection sensors 213 and 214 disposed in the side guide plates 212 is applied to the document size, even a document 100 having a small size included in the bundle of mixed document 100 is processed as a document 100 having a large size. This results in an increase in data size.

In the present embodiment, the detection result of the document width sensor 52, which is disposed on the conveyance path 23, is used. This configuration allows the document size determination section 432 to detect the size closest to the document size of each document 100. With this configuration, therefore, even when a bundle of documents 100 has different sizes, the document size determination section 432 determines the document size of each of the bundle of documents 100.

Referring back to FIG. 15, in step S7, the document cropping section 433 crops the image according to the document size determined by the document size determination section 432 or according to the document size detected by the document width sensor 52.

According to the present embodiment, even when the feature value detection section 431 has failed to detect the edges of the opposite ends of the document 100 in the main scanning direction due to some factor, it is less likely that the document width sensor 52, which is disposed on the conveyance path 23, also fails to detect the document size due to the same factor since the document size detection method employed by the document width sensor 52 is different from the method employed by the feature value detection section 431. Therefore, the document size determination section 432 successfully detects the document size using the detection result of the document width sensor 52.

Although the document width sensor 52 does not detect the document size of the document 100 as precisely as the feature value detection section 431 does by detecting the edges of the opposite ends of the document 100 in the main scanning direction, the document width sensor 52 is highly reliable in that the document width sensor 52 does not fail to detect the document size unless the document width sensor 52 physically breaks down. Assume a case where a bundle of mixed documents with different widths includes documents with a standard size and documents with a non-standard size. In this case, when a typical reading device has failed to automatically detect the document size of each of the bundle of mixed documents, the typical reading device uses the width of side fences instead of the width of each document, which is the subject. This results in detecting the document size significantly different from the actual document size of each document. With the configuration according to the present embodiment, the document size (the width of each subject) is reliably detected without failure.

In the present embodiment, as illustrated in FIG. 3, the document width sensor 52 is disposed such that the light-receiving devices 52a, 52b, and 52c are arranged in the lateral direction of documents 100 so as to correspond to the standard document sizes of the documents 100 placed along one of the side guide plates 212 serving as the document placement reference. However, the present disclosure is not limited thereto.

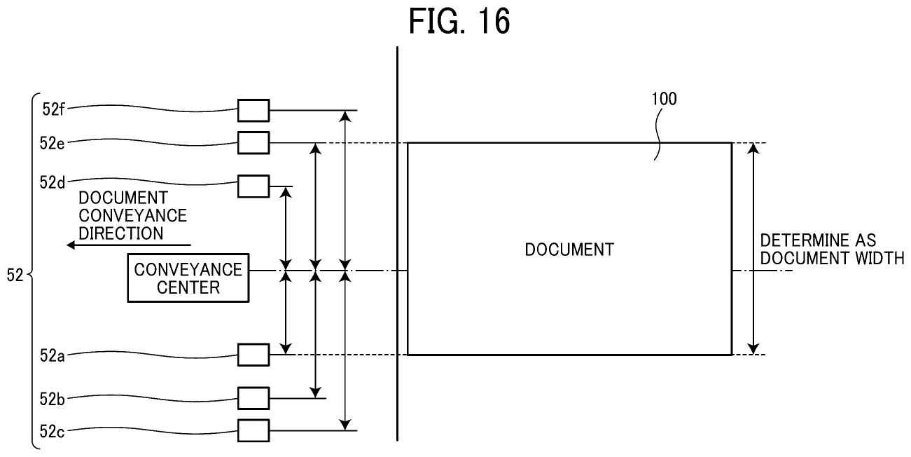

For example, as illustrated in FIG. 16, the document width sensor 52 may include light-receiving devices 52d, 52e, and 52f in addition to the light-receiving devices 52a, 52b, and 52c and some of the light-receiving devices 52a, 52b, 52c, 52d, 52e, and 52f are arranged on the right side of the conveyance path 23 and the others are arranged on the left side of the conveyance path 23.

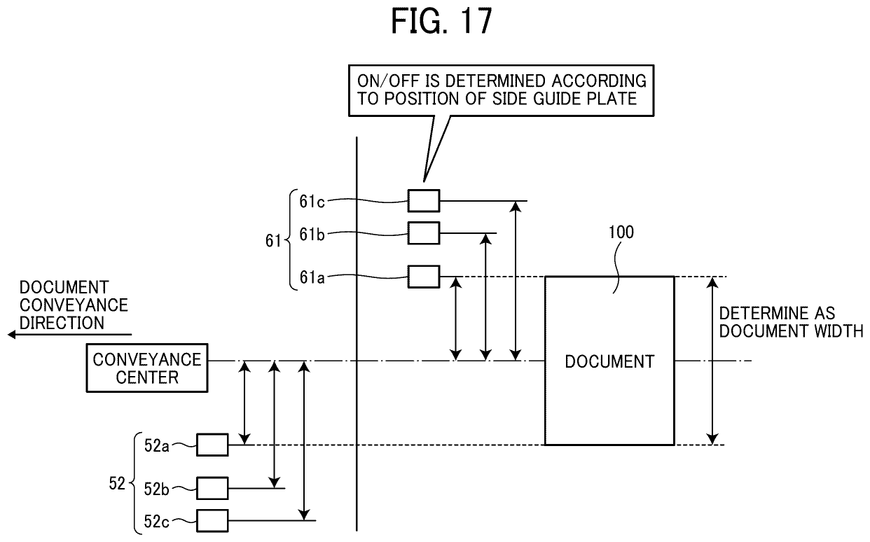

As another example, as illustrated in FIG. 17, the document width sensor 52 may be disposed such that the light-receiving devices 52a, 52b, and 52c are arranged on the conveyance path 23, and a guide plate sensor 61, which includes a plurality of light-receiving devices 61a, 61b, and 61c, may be disposed at a position closer to one of the side guide plates 212 of the tray 21 to detect the position of the slid side guide plate 212.

In the present embodiment, the document width sensor 52 of the ADF 102 is employed as the second width detector and the document size detected by the document width sensor 52 is applied. However, the present disclosure is not limited thereto. As long as the second width detector does not employ the edge detection method, the second width detector may employ any method to detect the document 100. For example, the second width detector may detect the document 100 without using a sensor. In this case, the second width detector may determine the presence or absence of the document 100 at a plurality of predetermined positions in an image read by the reading device 30 to determine the document width using information regarding a predetermined position where the document 100 has been determined to be present among the plurality of predetermined positions. In one example, the second width detector may determine the document width using the information indicating the presence or absence of the document 100 at a predetermined position one or two positions away in an outward direction from the predetermined position where the document 100 has been determined to be present among the plurality of predetermined positions. The outward direction herein indicates a direction toward the outside relative to the document placement reference. In another example, the second with detector may determine the document width using information indicating the presence or absence of the document 100 at the predetermined position one or two positions away from the center of the conveyance path 23 in the width direction. Since this method employs image processing that is different from the edge detection, the document is still detectable even when the edge detection has failed. With the method of determining the presence or absence of the document 100 at predetermined positions, the second width detector does not, indeed, detect the size of the document 100 as precisely as the edge detection does. This method, however, uses image data inside the document 100 instead of unstable document edges which are susceptible to the state of the document 100. With this method, therefore, the document size is determined with a high degree of reliability and the cost decreases due to the reduced number of sensors.

For example, the image processor 43 may be employed as the second width detector and the document size detected based on the image data read by the reading device 30 of the flatbed type may be applied. This configuration is described in detail below.

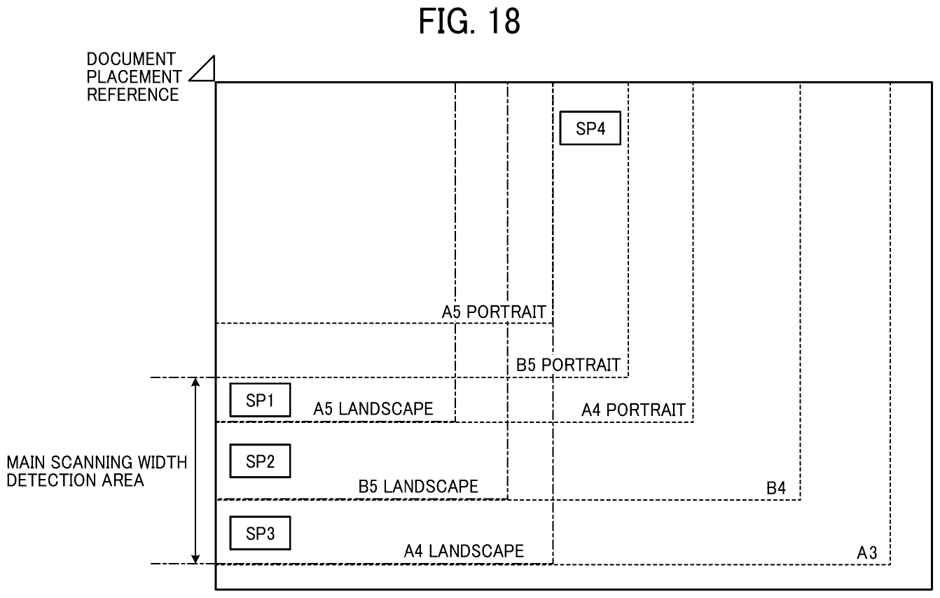

FIG. 18 is a top view of the exposure glass 11, illustrating a relationship between a document placement area on the exposure glass 11 and the positions of document size detection spots SP1 to SP4. Specifically, FIG. 18 illustrates the sizes of the standard documents that are detected when documents 100 having different sizes are placed on the exposure glass 11 along the document placement reference, which is one of the side guide plates 212. FIG. 18 also illustrates an example configuration of scanner light source blocks, each of which is a block of the light source 13 that is individually turned on and off. As illustrated in Table 1, the document size determination section 432 of the image reading device 101 detects the size of each document 100 according to a combination of the reading results of individual image data at the document size detection spots SP1 to SP4.

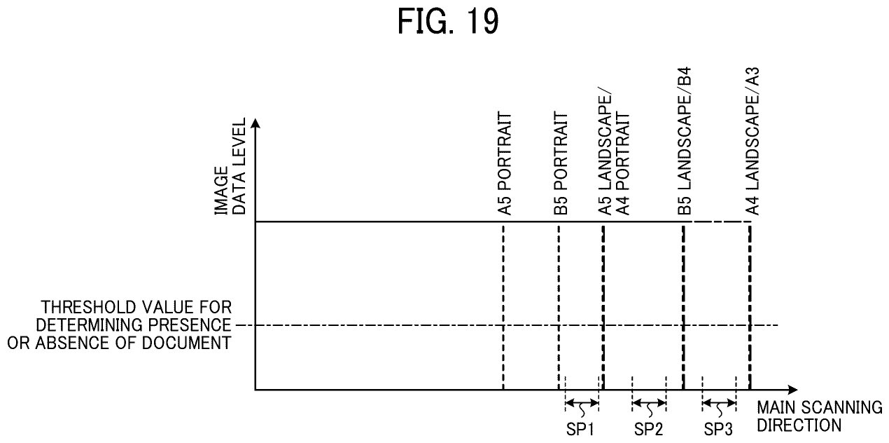

FIG. 19 is a diagram illustrating example image data levels when the document size determination section 432 determines the presence or absence of the document 100 in the main scanning direction using the document size detection spots SP1 to SP3. When the image reading device 101 detects the width of the document 100 in the main scanning direction, the image reading device 101 obtains image data in the main scanning direction at a position corresponding to a “main scanning width detection area” and uses the average data of the three document size detection spots SP1 to SP3 to detect an end of the document 100. When a blank sheet of each size is placed on the exposure glass 11, a combination of the main scanning position and the image data level (after shading correction) is as illustrated in FIG. 19. The image reading device 101 detects the end position of the document 100 from the image data of the document placement area to determine the width of the document 100 in the main scanning direction. To simplify the calculation, the average data of the areas SP1 to SP3 may be used to detect the width of the document 100.

When the image reading device 101 detects the width of the document 100 in the sub-scanning direction, the image reading device 101 detects the presence or absence of the document 100 using the image data level of the document size detection spot SP4. The image reading device 101 then combines the detection result of the width in the main scanning direction and the detection result of the width in the sub-scanning direction as illustrated in Table 1 to determine the size and orientation of the placed document 100.

TABLE 1

| Document Size | | | | | | |
|---|---|---|---|---|---|---|
| | | Dimensions | | | | |
| Size | Orien- | Main × Sub | Sport Reaction | | | |
| Name | tation | (mm) | SP1 | SP2 | SP3 | SP4 |
| A5 | Portrait | 140 × 210 | — | — | — | — |
| A5 | Land- | 210 × 148 | Ex- | — | — | — |
| | scape | | ceeded | | | |
| B5 | Portrait | 182 × 257 | — | — | — | Ex- |
| | | | | | | ceeded |
| B5 | Land- | 257 × 182 | Ex- | Ex- | — | — |
| | scape | | ceeded | ceeded | | |
| A4 | Portrait | 210 × 297 | Ex- | — | — | Ex- |
| | | | ceeded | | | ceeded |
| A4 | Land- | 297 × 210 | Ex- | Ex- | Ex- | — |
| | scape | | ceeded | ceeded | ceeded | |
| B4 | Portrait | 257 × 364 | Ex- | Ex- | — | Ex- |
| | | | ceeded | ceeded | | ceeded |
| A3 | Portrait | 297 × 420 | Ex- | Ex- | Ex- | Ex- |
| | | | ceeded | ceeded | ceeded | ceeded |

As illustrated in FIG. 19, for example, when the image data level exceeds a threshold value for determining the presence or absence of the document 100 at all the document size detection spots SP1 to SP3 in the main scanning direction, the document size determination section 432 determines that the size of the document 100 is A4 (landscape) or A3. The document size determination section 432 then determines, based on the image data level of the document size detection spot SP4, whether the size of the document 100 is A4 (landscape) or A3.

In this way, the second width detector, which employs a method different from the method employed by the first width detector, does not necessarily use a sensor to detect the document 100. With this configuration, the image size is determined at low cost without losing any information from the document 100.

### Second Embodiment

A second embodiment of the present disclosure is described below.

The second embodiment differs from the first embodiment in the processing for determining the document size using the document width sensor 52. The following description focuses on the differences from the first embodiment, omitting or minimizing the descriptions of the configurations, functions, processing, etc., that are the same or substantially the same as those described in the first embodiment.

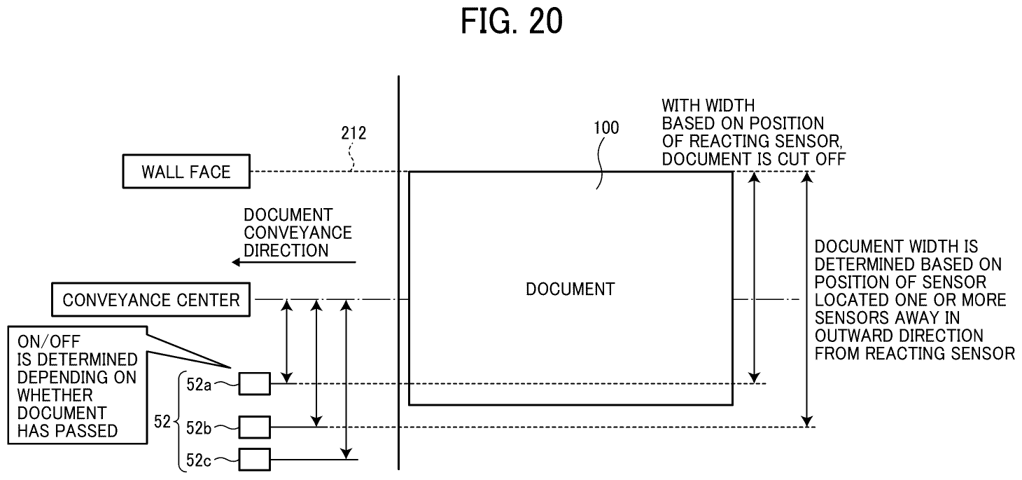

FIG. 20 is a diagram illustrating processing that is performed for determining the document size using the document width sensor 52 according to the second embodiment.

Assume a case where a document 100 having a non-standard size is included in a bundle of documents 100. In this case, with the configuration according to the first embodiment, it is difficult to recognize where an actual end of the document 100 is between a reacting light-receiving device of the document width sensor 52 and a light-receiving device of the document width sensor 52 next to the reacting light-receiving device in an outward direction among the light-receiving devices 52a, 52b, and 52c of the document width sensor 52. Therefore, in a case where the document size is determined based on the position of the reacting light-receiving device of the document width sensor 52 as in the case of the document 100 having the standard size, the end of the document 100 may be cut off, causing image loss.

Therefore, in the present embodiment, as illustrated in FIG. 20, the document size determination section 432 determines the document size of the document 100 based on the position of a light-receiving device of the document width sensor 52 located one or more light-receiving devices away in the outward direction from a light-receiving device of the document width sensor 52 that has actually detected the document 100 among the light-receiving devices 52a, 52b, and 52c of the document width sensor 52. This configuration prevents the end of the document 100 from being cut off and minimizes the width of a margin, thereby preventing an increase in data volume.

In the present embodiment, the document size determination section 432 determines, as the document size, the size closest to and larger than the actual document size. This configuration allows the document size determination section 432 to determine the image size with which information is not lost from the document 100.

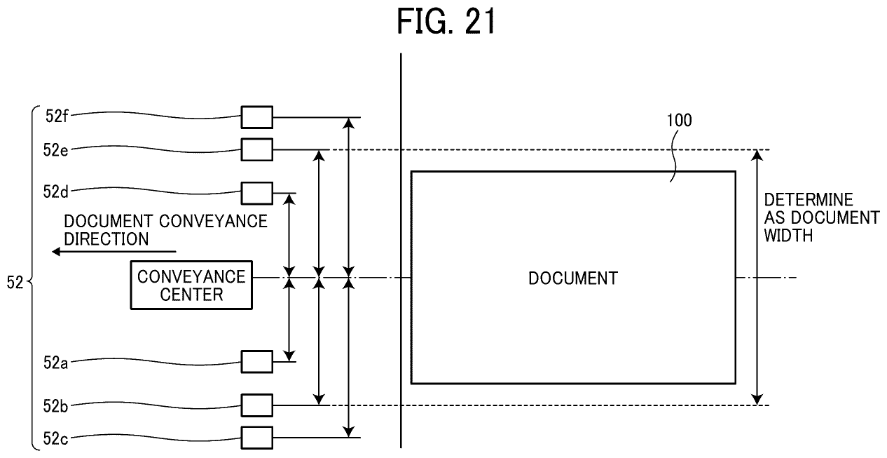

As illustrated in FIG. 21, the document width sensor 52 may include the light-receiving devices 52a, 52b, 52c, 52d, 52e, and 52f and some of the light-receiving devices 52a, 52b, 52c, 52d, 52c, and 52f are arranged on the right side of the conveyance path 23 and the others are arranged on the left side of the conveyance path 23 (see FIG. 16). In this case as well, the document size determination section 432 determines the document width using the position of the light-receiving device located next to the reacting light-receiving device in the outward direction. This configuration, therefore, ensures that the document size determination section 432 determines an optimal document width with which the end of the document 100 is not cut off.

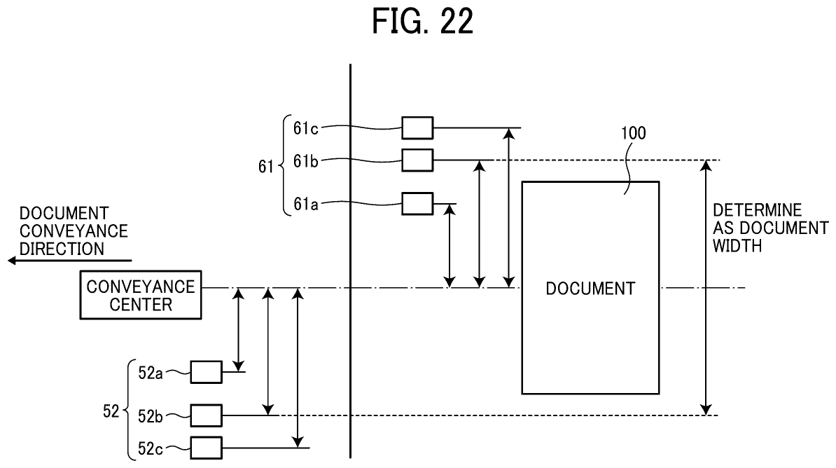

As illustrated in FIG. 22, the document width sensor 52 may be disposed such that the light-receiving devices 52a, 52b, and 52c are arranged on the conveyance path 23, and the guide plate sensor 61, which includes the plurality of light-receiving devices 61a, 61b, and 61c, may be disposed at a position closer to one of the side guide plates 212 of the tray 21 to detect the position of the side guide plate 212 (see FIG. 17). In this case as well, the document size determination section 432 determines the document width using the position of the light-receiving device next to the reacting light-receiving device in the outward direction. This configuration, therefore, ensures that the document size determination section 432 determines an optimal document width with which the end of the document 100 is not cut off. Note that, as illustrated in FIGS. 20 to 22, the outward direction herein indicates a direction toward the outside relative to the conveyance center indicated by a dashed-dotted line that passes through the center of the conveyance path 23 in the width direction (that is, the center of the maximum-possible width through which the document 100 can be conveyed).

### Third Embodiment

A third embodiment of the present disclosure is described below.

The third embodiment differs from the first and second embodiments in that the image reading device 101 includes a user interface that allows a user to adjust the image size which is the detection result of the document width of the document 100 to any desired size. The following description focuses on the differences from the first and second embodiments, omitting or minimizing the descriptions of the configurations, functions, processing, etc., that are the same or substantially the same as those described in the first and second embodiments.

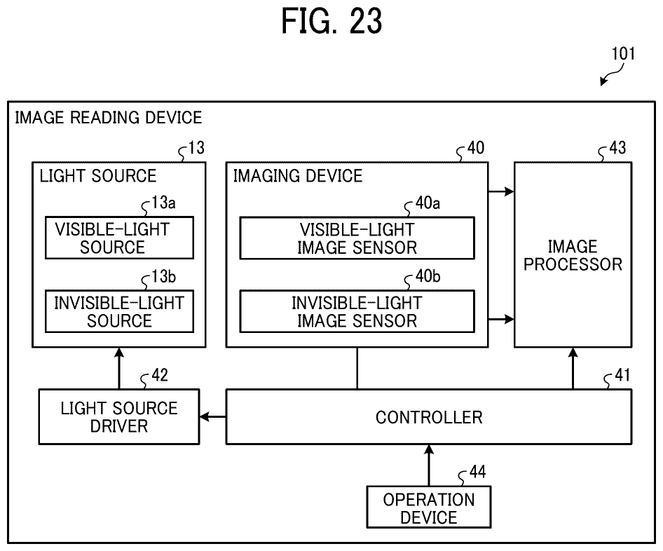

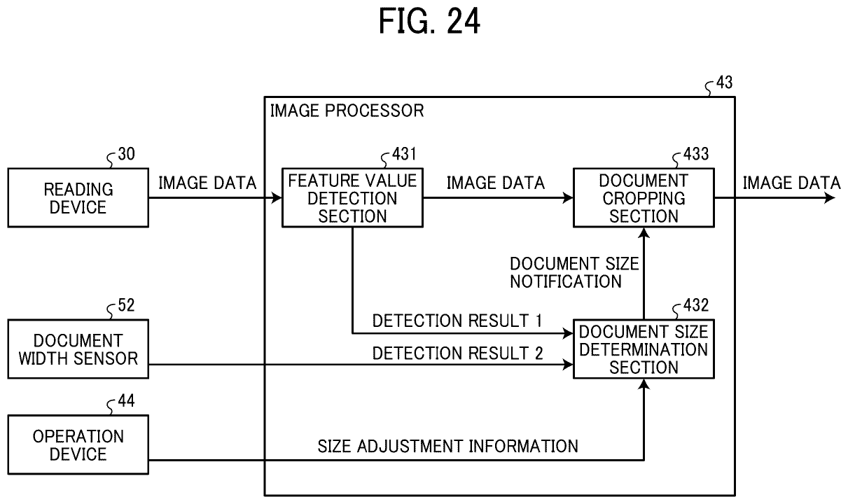

FIG. 23 is a block diagram illustrating the electrical connection of components included in the image reading device 101 according to the third embodiment. FIG. 24 is a block diagram illustrating a functional configuration of the image processor 43.

As illustrated in FIGS. 23 and 24, the image reading device 101 according to the present embodiment includes an operation device 44. The operation device 44 is, for example, a display with a touch panel.

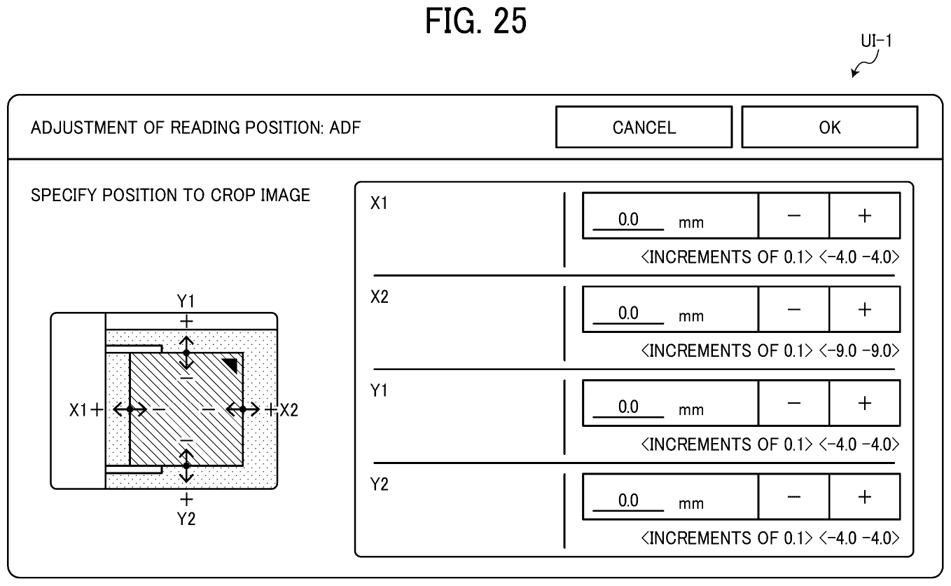

FIG. 25 is a view illustrating an example display on the operation device 44 when the document 100 is read by the ADF 102. As illustrated in FIG. 25, the operation device 44 implements a user interface UI-1 which allows the user to adjust the image size of an image which is the detection result of the width of the document 100 obtained by the document size determination section 432 to any size.

For example, there is a possibility that the detection of the document width by the document width sensor 52 may vary depending on the assembly accuracy. In the present embodiment, the user interface UI-1 allows the user to individually adjust the detection result of the document width of the document 100 obtained by the document width sensor 52. Specifically, as illustrated in FIG. 25, the document size determination section 432 adjusts the detected width of the document 100 according to the input of at least one of four directions X1, X2, Y1, and Y2 from the user interface UI-1.

In this way, the configuration according to the present embodiment allows the user to correct the detection result of the document 100 deviated due to variations caused by varying assembly accuracies or adjust the document size according to the user's preferences.

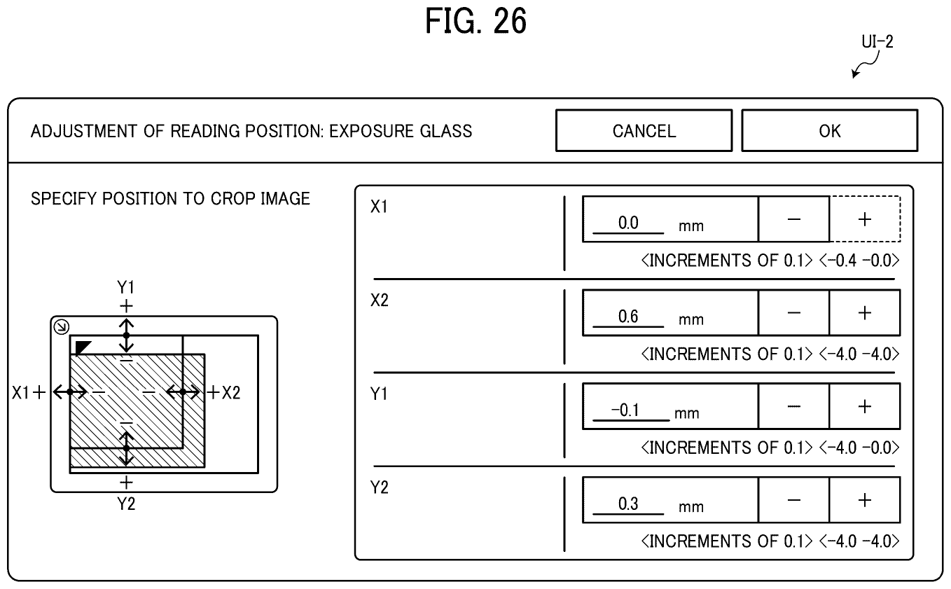

In the case of flatbed reading, the operation device 44 implements a user interface UI-2, which allows the user to adjust the image size which is the detection result of the width of the document 100 obtained by the document size determination section 432 to any size. FIG. 26 is a view illustrating an example display on the operation device 44 in the case of flatbed reading.

As illustrated in FIG. 26, the document size determination section 432 adjusts the detected width of the document 100 according to the input of at least one of the four directions X1, X2, Y1, and Y2 from the user interface UI-2.

In this way, the configuration according to the present embodiment allows the user to fine-tune the detected document size.

The program executed by the image forming apparatus 1 according to the above-described embodiments is recorded and provided as a file in an installable format or an executable format in any computer-readable recording medium such as a compact-disc read-only memory (CD-ROM), a flexible disk (FD), a compact-disc recordable (CD-R), or a digital versatile disc (DVD).

Further, the program executed by the image forming apparatus 1 according to the above-described embodiments may be stored in a computer connected to a network such as the Internet and downloaded via the network. Further, the program executed by the image forming apparatus 1 according to the above-described embodiments may be provided or distributed via a network such as the Internet. The program executed by the image forming apparatus 1 according to the above-described embodiments may be stored in a memory such as a read-only memory (ROM) in advance before provided.

The program executed by the image forming apparatus 1 according to the above-described embodiments has a module configuration including the above-described sections such as the feature value detection section 431 and the document size determination section 432. As the actual hardware, the CPU (processor) reads and executes the program from the above-described storage medium so that the above-described sections are loaded onto a main memory, thereby generating the feature value detection section 431 and the document size determination section 432 on the main memory.

The reading device according to the above-described embodiments has been described as being applied to a multifunction peripheral having at least two functions among the copy function, the printer function, the scanner function, and the facsimile function. Alternatively, the reading device according to the above-described embodiments may be applied to any image forming apparatus such as a copier, a printer, a scanner, or a facsimile.

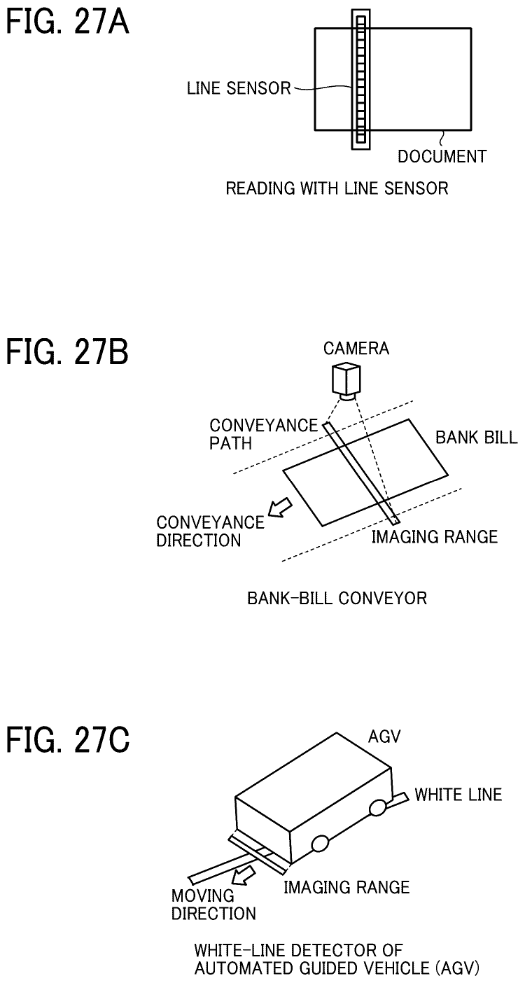

In the above-described embodiments, the image reading device 101 of the image forming apparatus 1 is employed as the reading device. However, the present disclosure is not limited thereto and the reading device is not necessarily a device that reads an image. Any device is employed as the reading device as long as the device obtains the reading level. One example is a line sensor of a unity magnification optical system (contact image sensor (CIS) system), as illustrated in FIG. 27A. The device illustrated in FIG. 27A causes a line sensor or a document to move to read information regarding a plurality of lines.

The reading device according to the above-described embodiments is also applicable to a bank-bill conveyor illustrated in FIG. 27B and a white-line detector of an automated guided vehicle (AGV) illustrated in FIG. 27C.

The subject of the bank-bill conveyor illustrated in FIG. 27B is a bank bill. For example, the feature value detected by the bank-bill conveyor may be used for the correction of the image itself. In other words, the bank-bill conveyor illustrated in FIG. 27B recognizes the angle of tilt of the bank bill through edge detection and performs the skew correction based on the recognized angle of tilt.

The subject of the white-line detector of the AGV illustrated in FIG. 27C is a white line. For example, the feature value detected by the white-line detector of the AGV may be used to determine the moving direction of the AGV. In other words, the white-line detector of the AGV performs edge detection to recognize the angle of tilt of a white-line area, and determines the moving direction of the AGV based on the recognized angle of tilt. The white-line detector of the AGV may correct the moving direction based on the position or orientation of the AGV in later processing. Another example of processing is such that the AGV stops driving when a white line having a thickness different from a known thickness is detected.

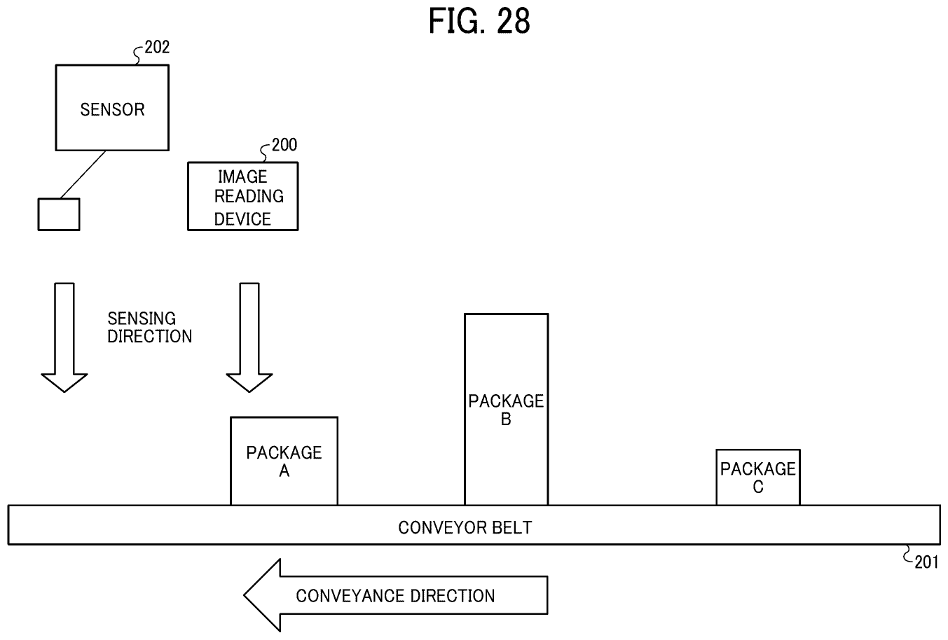

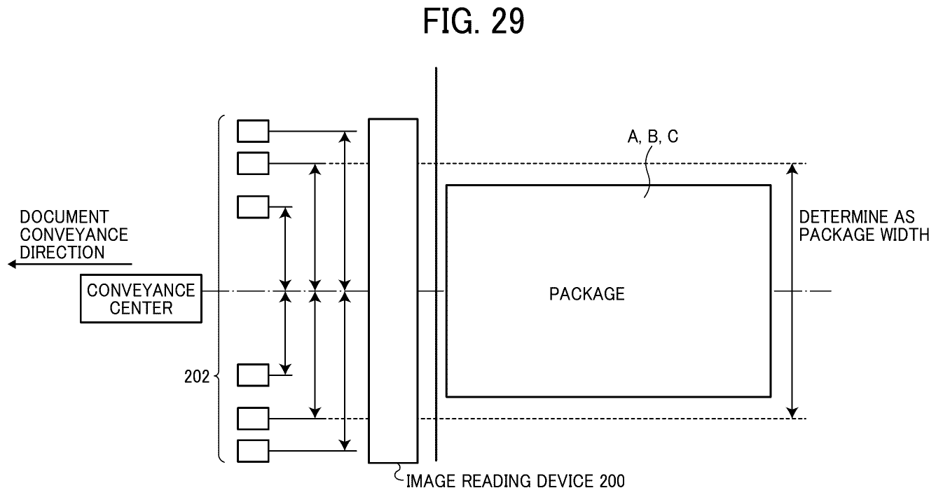

FIG. 28 is a diagram illustrating another modification of the reading device. FIG. 29 is a diagram illustrating an example arrangement of the document width sensor. The example illustrated in FIG. 28 illustrates an example of application to an image reading device 200 serving as the reading device used for packaging of goods at a production site, for example.

The subjects of the image reading device 200 illustrated in FIG. 28 are packages A, B, and C that are conveyable objects and have different sizes. As illustrated in FIG. 28, when the packages A, B, and C having different sizes are being conveyed on a conveyor belt 201, the image reading device 200 according to the present modification detects the feature values (edges) of the packages A, B, and C to detect the width of each of the packages A, B, and C. Visible light is effective for a black package and invisible light is effective for a white package when the feature values of the packages A, B, and C are detected.

In this case, the background member 26 may be a face of the conveyor belt 201. Alternatively, a dedicated background member 26 may be disposed with the reading position of the image reading device 200 set in a gap of the conveyor belt 201.

The image reading device 200 detects the feature values (edges) of the packages A, B, and C being conveyed and detects the width of each of the packages A, B, and C based on the results of the detection of the feature values of the packages A, B, and C to select the sizes of containers to be used for packaging. This configuration reduces waste such as the use of excessively large containers.

Further, when the image reading device 200 has failed to detect the width through image processing of the read images of the packages A, B, and C being conveyed, the image reading device 200 determines the width of each of the packages A, B, and C received from a sensor 202, which is disposed on a conveyance path including the conveyor belt 201 to detect the width of each of the packages A, B, and C being conveyed. Accordingly, the sizes of the containers or packaging materials used for packaging are selected based on the detection results. This configuration reduces waste such as the use of excessively large containers or packaging materials.

Aspects of the present disclosure are, for example, as follows.

According to Aspect 1, a reading device includes an illumination device, an imaging device, a first width detector, a second width detector, and a width determination section. The illumination device irradiates a subject with light. The imaging device receives the light reflected off the subject and generates an image. The first width detector detects a width of the subject. The second width detector detects the width of the subject using a different method from the first width detector. The width determination section determines a size of the subject. When the first width detector has detected the width of the subject normally, the width determination section determines the width of the subject based on a detection result of the first width detector. When the first width detector has not detected the width of the subject normally, the width determination section determines the width of the subject based on a detection result of the second width detector.

According to Aspect 2, in the reading device of Aspect 1, the first width detector detects edges of opposite ends of the subject in a main scanning direction of the imaging device to detect the width of the subject.

According to Aspect 3, the reading device of Aspect 1 or 2 further includes a conveyor to convey the subject. The second width detector uses a sensor that detects a passing position of the subject being conveyed to determine the width of the subject.

According to Aspect 4, in the reading device of Aspect 3, the sensor includes a plurality of light-receiving devices. The width determination section determines the width of the subject using position information of a light-receiving device located one or more light-receiving devices away in an outward direction from a light-receiving device that has reacted to the subject being conveyed among the plurality of light-receiving devices. The outward direction is a direction toward an outside relative to a conveyance center.

According to Aspect 5, in the reading device of any one of Aspects 1 to 4, the second width detector determines whether or not the subject is present at each of a plurality of predetermined positions in the image generated by the imaging device and determines the width of the subject using information indicating presence or absence of the subject at a predetermined position located one or more predetermined positions away in an outward direction from a predetermined position at which the subject has been determined to be present among the plurality of predetermined positions. The outward direction is a direction toward an outside relative to a document placement reference.

According to Aspect 6, in the reading device of Aspect 2, the illumination device irradiates the subject with visible light and invisible light. The imaging device receives the visible light and the invisible light reflected off the subject to capture a visible image and an invisible image. The first width detector detects the edges of the subject from at least one of the visible image and the invisible image.

According to Aspect 7, in the reading device of any one of Aspects 1 to 6, the width determination section adjusts the width of the subject according to an input from a user interface.

According to Aspect 8, in the reading device of Aspect 1, the subject includes a conveyable object.

According to Aspect 9, an image processing apparatus includes the reading device of any one of Aspects 1 to 8, and an image forming device.

According to Aspect 10, a reading method is performed by a reading device including an illumination device, an imaging device, a first width detector, a second width detector, and a width determination section. The illumination device irradiates a subject with light. The imaging device receives the light reflected off the subject and generates an image. The first width detector detects a width of the subject. The second width detector detects the width of the subject using a different method from the first width detector. The width determination section determines a size of the subject. The reading method includes, when the first width detector has detected the width of the subject normally, determining, by the width determination section, the width of the subject based on a detection result of the first width detector, and when the first width detector has not detected the width of the subject normally, determining, by the width determination section, the width of the subject based on a detection result of the second width detector.

According to Aspect 11, a program causes a computer that controls a reading device to function as a width determination section. The reading device includes an illumination device, an imaging device, a first width detector, and a second width detector. The illumination device irradiates a subject with light. The imaging device receives the light reflected off the subject and generates an image. The first width detector detects a width of the subject. The second width detector detects the width of the subject using a different method from the first width detector. The width determination section determines a size of the subject. When the first width detector has detected the width of the subject normally, the width determination section determines the width of the subject based on a detection result of the first width detector. When the first width detector has not detected the width of the subject normally, the width determination section determines the width of the subject based on a detection result of the second width detector.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A reading device comprising:
a light source to irradiate a subject with light;
an imaging device to receive the light reflected off the subject and generate an image;
a first width detector to detect a width of the subject;
a second width detector to detect the width of the subject using a different method from the first width detector; and
circuitry configured to determine a size of the subject, the circuitry being configured to:
when the first width detector has detected the width of the subject normally, determine the width of the subject based on a detection result of the first width detector; and
when the first width detector has not detected the width of the subject normally, determine the width of the subject based on a detection result of the second width detector.

2. The reading device according to claim 1, wherein the first width detector detects edges of opposite ends of the subject in a main scanning direction of the imaging device to detect the width of the subject.

3. The reading device according to claim 1, further comprising a conveyor to convey the subject,
wherein the second width detector includes a sensor that detects a position where the subject being conveyed has passed, and
the circuitry is configured to determine the width of the subject based on the detection result of the sensor.

4. The reading device according to claim 3,
wherein the sensor includes a plurality of light-receiving devices, and
the circuitry is configured to determine the width of the subject using position information of a light-receiving device located one or more light-receiving devices away in an outward direction from a light-receiving device that has reacted to the subject being conveyed among the plurality of light-receiving devices, the outward direction being a direction toward an outside relative to a conveyance center.

5. The reading device according to claim 1, wherein the second width detector determines whether or not the subject is present at each of a plurality of predetermined positions in the image generated by the imaging device and determines the width of the subject using information indicating presence or absence of the subject at a predetermined position located one or more predetermined positions away in an outward direction from a predetermined position at which the subject has been determined to be present among the plurality of predetermined positions, the outward direction being a direction toward an outside relative to a document placement reference.

6. The reading device according to claim 2,
wherein the light that the light source irradiates includes visible light and invisible light,
the imaging device receives the visible light and the invisible light reflected off the subject to capture a visible image and an invisible image, and
the first width detector detects the edges of the subject from at least one of the visible image and the invisible image.

7. The reading device according to claim 1, wherein the circuitry is configured to adjust the width of the subject according to an input from a user interface.

8. The reading device according to claim 1, wherein the subject includes a conveyable object.

9. An image processing apparatus comprising:
the reading device according to claim 1; and
an image forming device to form an image of a document that is the subject.

10. A reading method for reading a subject, performed by a reading device including a first width detector and a second width detector, the method comprising:
determining whether the first width detector has detected a width of the subject normally;
when the determining determines that the first width detector has detected the width of the subject normally, determining the width of the subject based on a detection result of the first width detector; and
when the determining determines that the first width detector has not detected the width of the subject normally, determining the width of the subject based on a detection result of the second width detector that detects the width of the subject using a different method from the first width detector.

11. A non-transitory recording medium storing a plurality of instructions which, when executed by one or more processors on a reading device including a first width detector and a second width detector, causes the one or more processors to perform a reading method for reading a subject, the method comprising:
determining whether the first width detector has detected a width of the subject normally;
when the determining determines that the first width detector has detected the width of the subject normally, determining the width of the subject based on a detection result of the first width detector; and
when the determining determines that the first width detector has not detected the width of the subject normally, determining the width of the subject based on a detection result of the second width detector that detects the width of the subject using a different method from the first width detector.
